(19) United States
(12) Patent Application Publication
(10) Pub. No.: US 2022/0276509 A1
(43) Pub. Date: Sep. 1, 2022

(54) Optical Measurement System Integrated into a Wearable Glasses Assembly

(71) Applicant: HI LLC, Los Angeles, CA (US)

(72) Inventors: Bryan Johnson, Culver City, CA (US); Ryan Field, Culver City, CA (US)

(21) Appl. No.: 17/665,886

(22) Filed: Feb. 7, 2022

Related U.S. Application Data
(60) Provisional application No. 63/196,917, filed on Jun. 4, 2021.
(60) Provisional application No. 63/154,131, filed on Feb. 26, 2021.

(51) Int. Cl. G02C 7/08; G02B 27/01

(52) U.S. Cl. CPC G02C 7/086; G02B 27/0172; G02B 2027/014; G02B 2027/0178; G02B 2027/0123

(57) ABSTRACT

An illustrative system includes a wearable glasses assembly configured to be worn by a user and comprising a viewing lens assembly configured to provide the user with a visual experience in which the user sees a real-world environment through the viewing lens assembly and an optical measurement system configured to output optical measurement data representative of one or more optical measurements performed with respect to the user.

### RELATED APPLICATIONS

The present application claims priority under 35 U.S.C. § 119(e) to U.S. Provisional Patent Application No. 63/196,917, filed on Jun. 4, 2021, and to U.S. Provisional Patent Application No. 63/154,131, filed Feb. 26, 2021, each of which are incorporated herein by reference in their respective entireties.

### BACKGROUND INFORMATION

Visual content (e.g., what a person sees in his or her surroundings, by way of a display screen, etc.) can greatly affect a person's mental state, ability to think clearly and/or perform physical tasks, exercise impulse control, interact with others, and/or otherwise function mentally and/or physically. Accordingly, it would be desirable to be able to determine this effect as the person experiences the visual content and perform one or more operations that modify the visual content, help the user achieve a desired mental state, and/or optimize the user's ability to function mentally and/or physically.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary wearable glasses assembly.

FIG. 2 shows an exemplary system that includes a wearable glasses assembly and a processor.

FIGS. 3A-3B show exemplary implementations of the system of FIG. 2.

FIG. 4 shows a configuration in which a processor may be configured to adjust one or more attributes of a visual experience by controlling an operation of a wearable glasses assembly.

FIG. 5 shows a configuration in which a processor may be configured to adjust one or more attributes of a visual experience by controlling an operation of a computing device communicatively coupled to a wearable glasses assembly.

FIG. 6 shows a configuration in which a wearable glasses assembly includes an imaging device configured to capture one or more images of a real-world environment as seen by the user.

FIG. 7 shows a configuration in which a wearable glasses assembly includes a microphone configured to detect sound in a real-world environment.

FIGS. 8-9 show implementations of a wearable glasses assembly.

FIGS. 10-12 show exemplary optical measurement systems.

FIG. 13 shows an exemplary computing system.

FIG. 14 illustrates an exemplary computing device.

FIG. 15 illustrates an exemplary method.

### DETAILED DESCRIPTION

An illustrative wearable glasses assembly configured to be worn by a user may include a viewing lens assembly configured to provide the user with a visual experience in which the user sees a real-world environment through the viewing lens assembly and an optical measurement system configured to output optical measurement data representative of one or more optical measurements performed with respect to the user.

In some examples, a processor (e.g., a processor included in the wearable glasses assembly and/or in a device separate from the wearable glasses assembly) may be configured to perform, based on the optical measurement data, an operation with respect to the visual experience. For example, the processor may adjust, based on the optical measurement data, one or more attributes associated with the visual experience (e.g., by controlling an operation of the wearable glasses assembly and/or a computing device communicatively coupled to the wearable glasses assembly based on the optical measurement data).

The devices, systems, and methods described herein may provide a number of advantages and benefits over conventional wearable glasses assemblies. For example, by including an optical measurement system in a wearable glasses assembly, brain activity data and/or other types of optical measurement data may be acquired while the user is experiencing visual content by way of the wearable glasses assembly. Based on the optical measurement data, a processor may determine, e.g., in real time, an effect of the visual experience on the user and adjust one or more attributes associated with the visual experience accordingly. For example, as described herein, the visual experience itself may be adjusted, other content (e.g., audio content and/or one or more notifications) may be presented to the user, and/or one or more other operations may be performed to help the user achieve a desired mental state, exercise impulse control, and/or more effectively perform one or more mental and/or physical tasks. These and other advantages and benefits of the devices, systems, and methods described herein are described more fully herein.

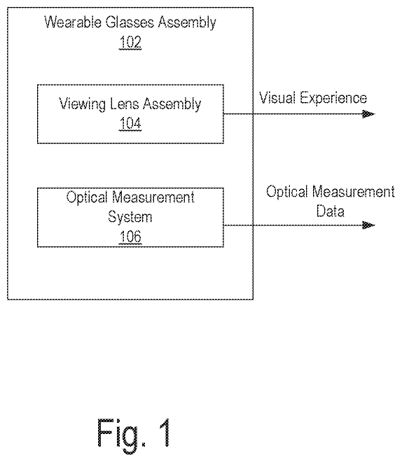

FIG. 1 illustrates an exemplary wearable glasses assembly 102 in accordance with the principles described herein. In some examples, wearable glasses assembly 102 is wearable by a user. For example, wearable glasses assembly 102 may be worn on a user's head (e.g., a frame of wearable glasses assembly 102 may be worn over the user's ears and on a bridge of the user's nose, similar to conventional eye glasses).

Wearable glasses assembly 102 may be implemented by any suitable apparatus configured to provide a visual experience to a user. For example, wearable glasses assembly 102 may be implemented by prescription eye glasses, reading glasses, sunglasses, smart glasses (e.g., a wearable glasses assembly comprising a processor configured to present augmented reality content to the user), and/or any other suitable eye piece(s) as may serve a particular implementation.

As used herein, a visual experience is one in which the user sees a real-world environment through wearable glasses assembly 102 (e.g., through viewing lenses of wearable glasses assembly 102, as described herein). The visual experience may also include presenting augmented reality content and/or any other type of content to the user.

As shown, wearable glasses assembly 102 includes a viewing lens assembly 104. Viewing lens assembly 104 may be configured to provide the user with a visual experience in which the user sees a real-world environment through viewing lens assembly 104. For example, viewing lens assembly 104 may include a first viewing lens configured to be positioned in front of a first eye of the user and a second viewing lens configured to be positioned in front of a second eye of the user. In this configuration, the user may see a real-world environment (i.e., a physical surroundings) of the user through the first and second viewing lenses. In some alternative configurations, viewing lens assembly 104 may include only a single viewing lens through which both eyes can see the real-world environment or through which only a single eye can see the real-world environment. It will be assumed in the examples provided herein that viewing lens assembly 104 includes two viewing lenses, one for each eye.

The one or more viewing lenses included in viewing lens assembly 104 may be made out of any suitable material, such as glass, plastic, and/or any other at least semi-transparent material through which the user can see.

In some example, viewing lens assembly 104 may be further configured to display augmented reality content associated with the real-world environment. For example, one or both of the viewing lenses included in viewing lens assembly 104 may include display capabilities such that the augmented reality content may be presented to the user by way of the viewing lens(es). The augmented reality content may add digital elements to a live view of the user. This is described more fully in U.S. Patent Application Nos. 63/139,469 and 63/139,478, the contents of which are incorporated herein by reference in their entirety.

Wearable glasses assembly 102 further includes an optical measurement system 106. Optical measurement system 106 may be included in wearable glasses assembly 102 in any suitable manner. Exemplary configurations in which optical measurement system 106 is included in (also referred to as “integrated into”) wearable glasses assembly 102 are described herein.

Optical measurement system 106 is configured to output optical measurement data, which may be generated using any suitable time domain-based optical measurement technique, such as time-correlated single-photon counting (TCSPC), time domain near infrared spectroscopy (TD-NIRS), time domain diffusive correlation spectroscopy (TD-DCS), and/or time domain digital optical tomography (TD-DOT). In some examples, the optical measurement data may include brain activity data representative of brain activity of the user. Additionally or alternatively, the optical measurement data may be representative of one or more non-invasive measurements of blood oxygen saturation (SaO2) through Time-Resolved Pulse Oximetry (TR-SpO2). Exemplary implementations of optical measurement system 106 are described herein.

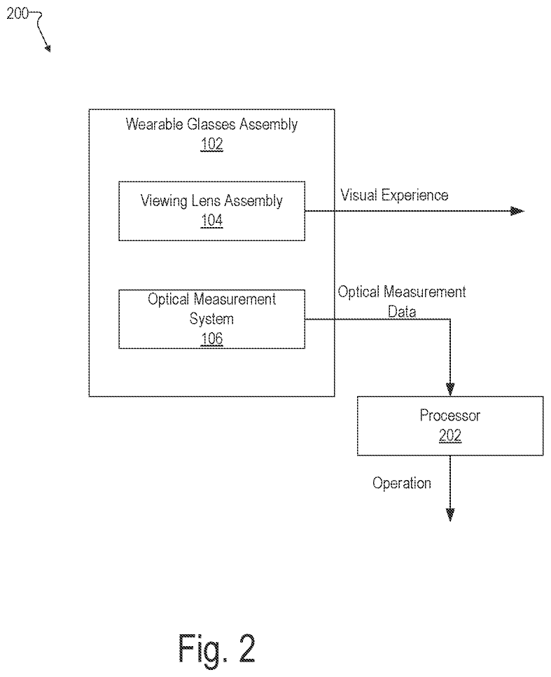

FIG. 2 shows an exemplary system 200 that includes wearable glasses assembly 102 and a processor 202. Processor 202 is configured to receive, as an input, the optical measurement data output by optical measurement system 106. Processor 202 may be further configured to perform, based on the optical measurement data, an operation with respect to the visual experience. Exemplary operations that may be performed by processor 202 are described herein.

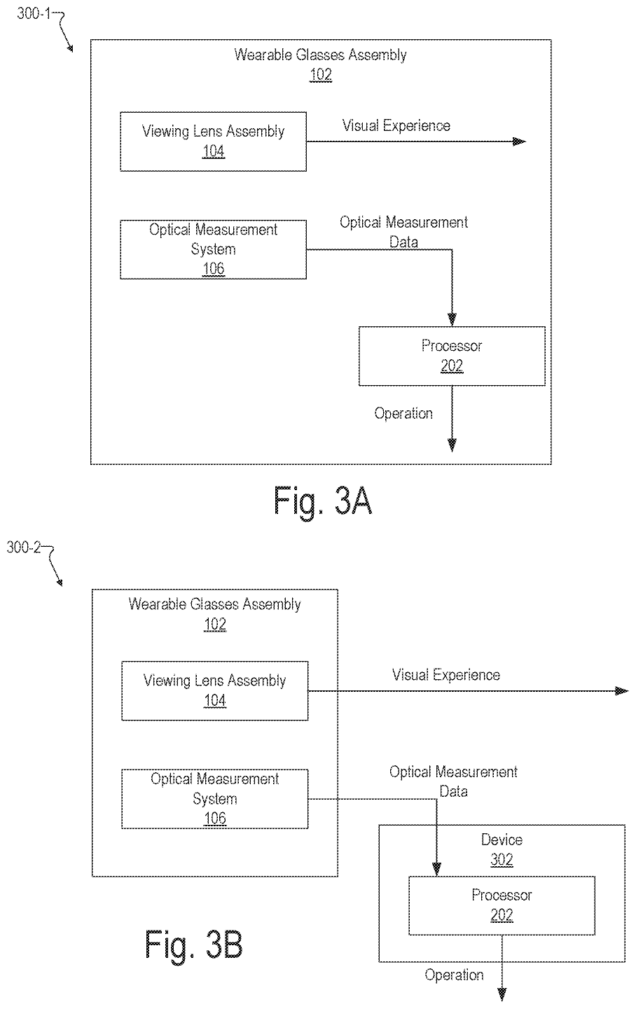

Processor 202 may be implemented by any suitable processing or computing device. Moreover, processor 202 may be included in any suitable device. To illustrate, FIG. 3A shows an implementation 300-1 in which processor 202 is included in wearable glasses assembly 102. FIG. 3B shows an alternative implementation 300-2 in which processor 202 is included in a device 302 separate from wearable glasses assembly 102. Device 302 may be implemented by any suitable housing and/or computing device as may serve a particular implementation. For example, device 302 may be implemented by a mobile device (e.g., a mobile phone, a smartphone, a tablet computer, a digital notebook, etc.) used by the user and configured to communicatively couple to wearable glasses assembly 102. In some examples, device 302 is wearable by the user.

Exemplary operations that may be performed by processor 202 based optical measurement data output by optical measurement system 106 will now be described. The operations described herein are merely illustrative of the many different operations that may be performed by processor 202 in accordance with the principles described herein.

In some examples, processor 202 may adjust, based on the optical measurement data, one or more attributes associated with the visual experience. This may be performed in any suitable manner. For example, processor 202 may transmit (e.g., wirelessly or by way of a wired connection) one or more commands to wearable glasses assembly 102 and/or a computing device communicatively coupled to wearable glasses assembly 102.

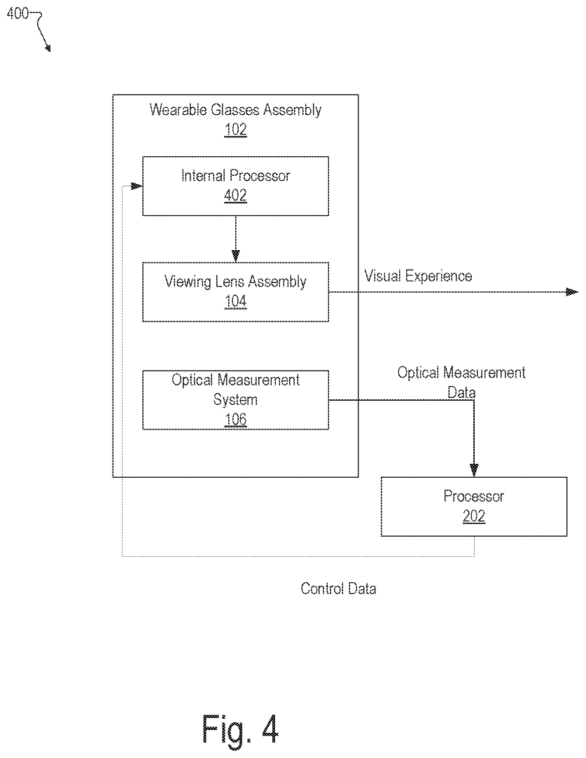

To illustrate, FIG. 4 shows a configuration 400 in which processor 202 may be configured to adjust one or more attributes associated with the visual experience by controlling an operation of wearable glasses assembly 102. As shown, in configuration 400, wearable glasses assembly 102 may include an internal processor 402. Internal processor 402 may be configured to provide wearable glasses assembly 102 with processing functionality, such as controlling one or more attributes (e.g., tinting, color filtering, etc.) of viewing lens assembly 104, generating augmented reality content associated with the real-world environment for presentation by way of viewing lens assembly 104, etc.

As shown in FIG. 4, processor 202 is configured to output control data based on the optical measurement data. The control data may be transmitted to internal processor 402 and may include one or more commands configured to direct internal processor 402 to perform one or more operations. For example, the control data may direct internal processor 402 to adjust a tint level of the viewing lenses included in viewing lens assembly 104, a color filtering level of the viewing lenses included in viewing lens assembly 104, a vision correction level of the viewing lenses included in viewing lens assembly 104, and/or any other attribute of the viewing lenses included in viewing lens assembly 104. Additionally or alternatively, the control data may direct internal processor 402 to generate augmented reality content for presentation to the user by way of viewing lens assembly 104, update augmented reality content already being presented to the user by way of viewing lens assembly 104, cease presenting augmented reality content already being presented to the user by way of viewing lens assembly 104, present other types of content to the user (e.g., audio content, one or more notifications, reminders, alarms, etc.), and/or perform any other operation with respect to the visual experience as may serve a particular implementation.

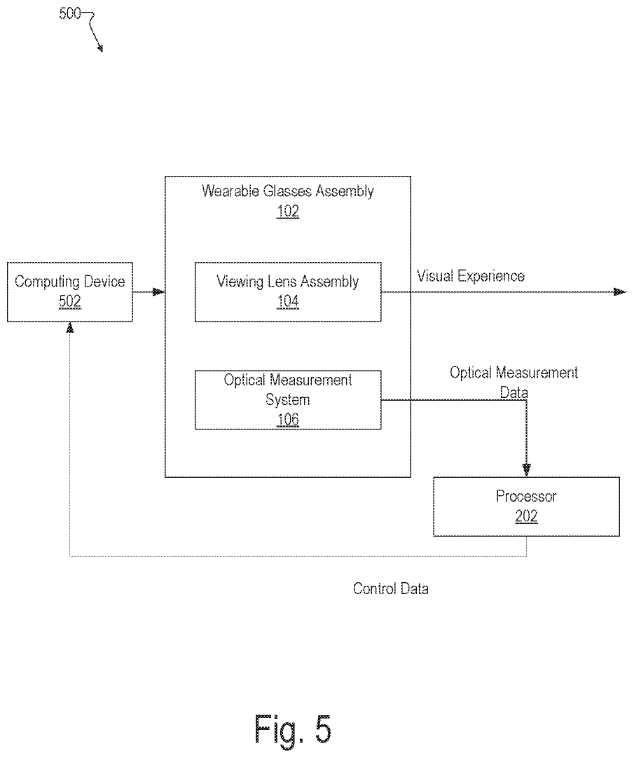

FIG. 5 shows a configuration 500 in which processor 202 may be configured to adjust one or more attributes associated with the visual experience by controlling an operation of a computing device 502 communicatively coupled to wearable glasses assembly 102. Computing device 502 may be implemented by any suitable computing device configured to interact with wearable glasses assembly 102. For example, computing device 502 may be implemented by a mobile device (e.g., a mobile phone, a smartphone, a tablet computer, a digital notebook, etc.), a gaming device, a television, a portable media player, etc.

As shown in FIG. 5, processor 202 is configured to output control data based on the optical measurement data. The control data may be transmitted to computing device 502 and may include one or more commands configured to direct computing device 502 to perform one or more operations. For example, the control data may direct computing device 502 to perform any of the operations described in connection with the internal processor 402, FIG. 4.

In some examples, computing device 502 is not communicatively coupled to wearable glasses assembly 102, but still configured to control one or more attributes of the visual experience provided by way of wearable glasses assembly 102. For example, computing device 502 may be configured to display (or control the display of) visual content included in the visual experience. Such visual content may include video content displayed, for example, by way of a screen of or communicatively coupled to computing device 502. In these examples, computing device 502 may adjust one or more attributes of the visual experience by controlling one or more attributes of the video content being display by way of the screen.

In either configuration 400 (FIG. 4) or configuration 500 (FIG. 5), processor 202 may be configured to adjust, based on the optical measurement data, one or more attributes associated with the visual experience in any suitable manner. For example, processor 202 may determine, based on the optical measurement data, “an effect” of the visual experience on the user. Processor 202 may adjust the one or more attributes associated with the visual experience based on the determined effect.

As used herein “an effect” may be related to an effect on the user's metal state or physiological functions of the user. Mental states may include joy, excitement, relaxation, surprise, fear, stress, anxiety, sadness, anger, disgust, contempt, contentment, calmness, approval, focus, attention, creativity, cognitive assessment, positive or negative reflections/attitude on experiences or the use of objects, etc. The cognitive assessment may encompass intellectual functions and processes (e.g., memory retrieval, focus, attention, creativity, reasoning, problem solving, decision making, comprehension and production of language, etc.). Physiological functions of the user may include, e.g., heart rate, respiratory rate, body temperature, blood pressure, skin conductivity, and/or an increase or decrease in these functions. Furthermore, “an effect” may include sensation of pain, an increase in the pain sensation, etc., as described more fully in U.S. Provisional Application No. 63/188,783, filed May 14, 2021, and incorporated herein by reference in its entirety.

As another example, processor 202 may determine, based on the optical measurement data, a current mental state of the user. Processor 202 may be further configured to obtain data representative of a desired mental state of the user (e.g., by way of user input provided by the user and/or based on an activity being performed by the user). Based on the current mental state and the desired mental state, processor 202 may adjust one or more attributes associated with the visual experience to change the current mental state of the user to the desired mental state of the user.

As used herein, mental states may include joy, excitement, relaxation, surprise, fear, stress, anxiety, sadness, anger, disgust, contempt, contentment, calmness, approval, focus, attention, creativity, cognitive assessment, positive or negative reflections/attitude on experiences or the use of objects, etc. Further details on the methods and systems related to a predicted brain state, physiological functions, behavior, preferences, or attitude of the user, and the creation, training, and use of neuromes can be found in U.S. patent application Ser. No. 17/188,298, filed Mar. 1, 2021, issued as U.S. Pat. No. 11,132,625. Exemplary measurement systems and methods using biofeedback for awareness and modulation of mental state are described in more detail in U.S. patent application Ser. No. 16/364,338, filed Mar. 26, 2019, issued as U.S. Pat. No. 11,006,876. Exemplary measurement systems and methods used for detecting and modulating the mental state of a user using entertainment selections, e.g., music, film/video, are described in more detail in U.S. patent application Ser. No. 16/835,972, filed Mar. 31, 2020, issued as U.S. Pat. No. 11,006,878. Exemplary measurement systems and methods used for detecting and modulating the mental state of a user using product formulation from, e.g., beverages, food, selective food/drink ingredients, fragrances, and assessment based on product-elicited brain state measurements are described in more detail in U.S. patent application Ser. No. 16/853,614, filed Apr. 20, 2020, issued as U.S. Pat. No. 11,172,869. Exemplary measurement systems and methods used for detecting and modulating the mental state of a user through awareness of priming effects are described in more detail in U.S. patent application Ser. No. 16/885,596, filed May 28, 2020, published as US2020/0390358A1. Exemplary measurement systems and methods used for wellness therapy, such as pain management regime, are described more fully in U.S. Provisional Application No. 63/188,783, filed May 14, 2021. These applications and corresponding U.S. patents and publications are incorporated herein by reference in their entirety.

By way of example, while the user is viewing a particular video by way of wearable glasses assembly 102, the optical measurement data output by optical measurement system 106 may indicate that the video is making the user experience an effect (e.g., feeling anxious), tempting the user to indulge in an undesirable behavior (e.g., by seeing a visual trigger that makes the user want to smoke, drink alcohol, etc.), lessoning the user's ability to exercise impulse control, and/or lessening the user's ability to think clearly about a task at hand. Based on this, processor 202 may adjust one or more attributes of the current video itself (e.g., by filtering out certain portions of the video, adjusting a volume level of the video, etc.), stop a presentation of the video, switch to presenting a different video in place of the current video, etc.

As another example, while a user is wearing wearable glasses assembly 102 outside in bright sunlight, the optical measurement data output by optical measurement system 106 may indicate that the sunlight is negatively affecting the ability of the user to experience an effect (e.g., less attentive and/or unable to focus and think clearly). Based on this, processor 202 may increase a tinting of the viewing lenses included in viewing lens assembly 104.

As another example, while a user is viewing a particular real-world scene, the optical measurement data output by optical measurement system 106 may indicate that the user is experiencing a physiological function, e.g., user's heartrate increases above a threshold amount. This may be a sign that the user is nervous, anxious, and/or excited. Based on this, processor 202 may present calming audio and/or visual content to the user to help the user minimize or decrease the physiological function where the user experiences a more relaxed mental state, e.g., calmness.

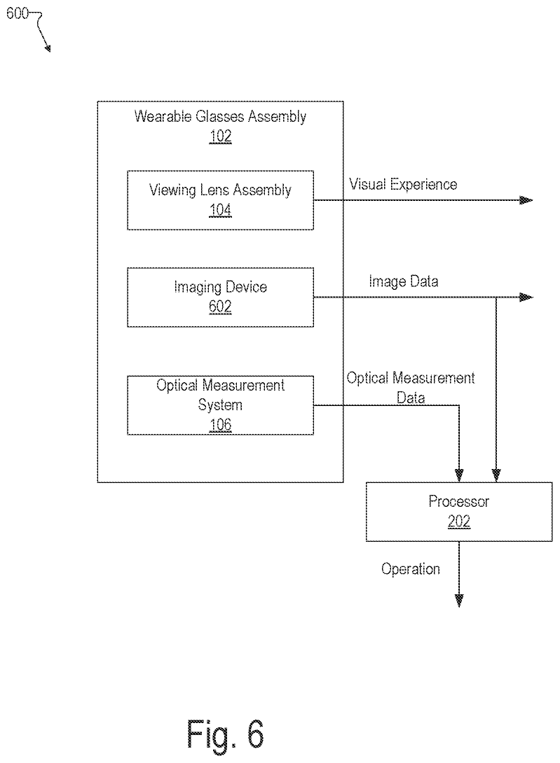

FIG. 6 shows a configuration 600 in which wearable glasses assembly 102 includes an imaging device 602 configured to capture one or more images of the real-world environment as seen by the user. Imaging device 602 may be implemented by any suitable camera as may serve a particular implementation. In some examples, imaging device 602 is integrated into viewing lens assembly 104 so that the images are captured from a field of view that is similar to that of the user.

As shown, imaging device 602 may output imaging data, which may be representative of the one or more captured images. The imaging data may be provided as an input to processor 202, which may be configured to perform an operation based on both the optical measurement data and the image data.

To illustrate, processor 202 may be configured to identify, based on the one or more images, a real-world object in a field of view of the user. The operation performed by processor 202 may accordingly be based on the optical measurement data and the identification of the real-world object.

For example, processor 202 may identify, based on the one or more images, that the user sees an unhealthy food item (e.g., a cookie, or a sweet dessert). Processor 202 may further determine, based on the optical measurement data, that the user is tempted to eat the food item. Processor 202 may accordingly provide the user with one or more notifications (e.g., audio and/or visual cues) that help the user overcome the temptation to eat the unhealthy food item.

As another example, processor 202 may be configured to identify, based on the one or more images, another person in a field of view of the user. Processor 202 may be further configured to determine one or more attributes of the other person. For example, processor 202 may determine one or more physical traits of the user, whether the user has seen the other person before, an identity of the other person, whether the other person is in a contact list and/or friend list of the user, etc. Processor 202 may accordingly base the operation that it performs on the one or more attributes of the other person.

For example, the optical measurement data may indicate that the user is subconsciously attracted to the other person, e.g., the measurement data includes a mental state of joy or excitement when the user is in the presence of the other person. Processor 202 may accordingly include one or more attributes of the other person in an attribute profile of people that the user is attracted to. The attribute profile may then be used to identify potential dating candidates for the user. Processor 202 may additionally or alternatively notify the user that he or she is attracted subconsciously to the other person.

As another example, the optical measurement data may indicate that the user is subconsciously threatened by the other person, e.g., the measurement data includes metal state of being afraid. Processor 202 may accordingly warn the user that he or she should exercise caution in the presence of the other person.

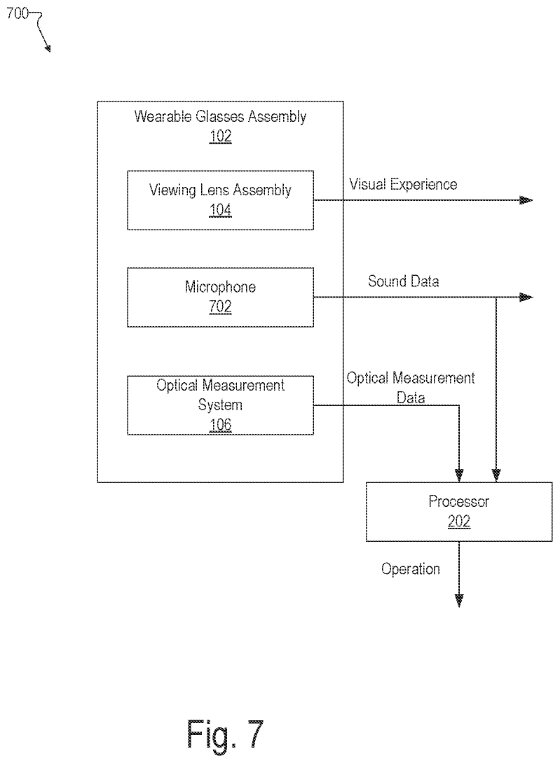

FIG. 7 shows a configuration 700 in which wearable glasses assembly 102 includes a microphone 702 configured to detect sound in the real-world environment. Microphone 702 may be integrated into wearable glasses assembly 102 in any suitable manner.

As shown, microphone 702 may output sound data, e.g., music; audio from a movie, a theater show, a lecture, a lesson, which may be representative of the detected sound. The sound data may be provided as an input to processor 202, which may be configured to perform an operation based on both the optical measurement data and the sound data.

In some examples, processor 202 may present, by way of a graphical user interface, content associated with the optical measurement data. For example, processor 202 may present one or more graphs, recommendations, directions, information, etc. based on the optical measurement data and the visual experience presented to the user.

Optical measurement system 106 may be included in wearable glasses assembly 102 in any suitable manner. For example, optical measurement system 106 may be included in and/or attached to a frame of wearable glasses assembly 102.

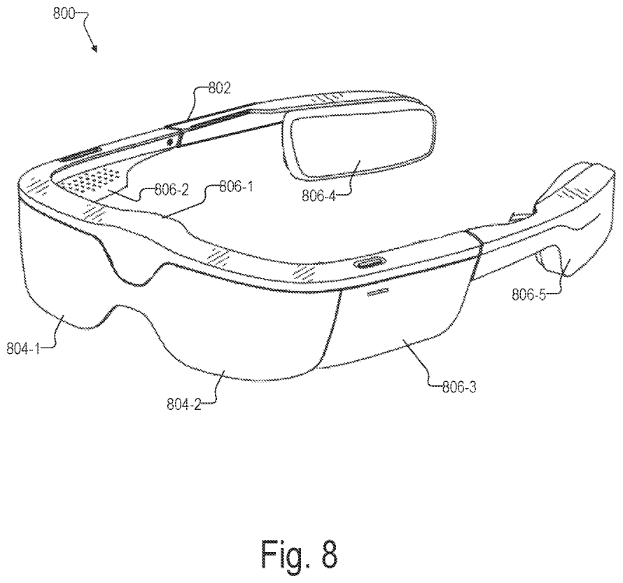

To illustrate, FIG. 8 shows an implementation 800 of wearable glasses assembly 102 in which wearable glasses assembly 102 includes a frame 802 configured to be worn by a user. Also shown are viewing lenses 804-1 and 804-2, which are attached to frame 802 in any suitable manner. Optical measurement system 106 may be included in or attached to any portion of frame 802 as may serve a particular implementation. For example, optical measurement system 106 may be included at one or more of locations 806-1 through 806-5 of frame 802. In this manner, optical measurement system 106 may be able to perform optical measurement operations with respect to different locations on the user's head.

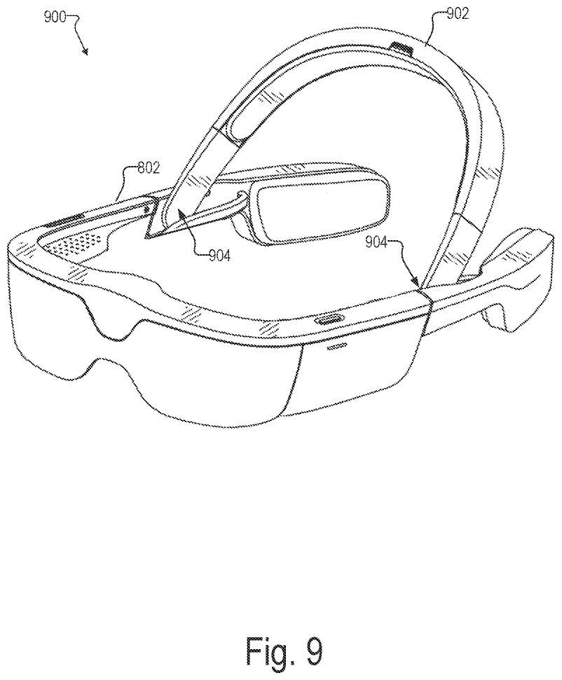

As another example, FIG. 9 shows an implementation 900 of wearable glasses assembly 102 in which wearable glasses assembly 102 includes a headband 902 connected to frame 802 and configured to be worn on a head of the user. In some examples, optical measurement system 106 may be included in or attached to any portion of headband 902. In this manner, optical measurement system 106 may be able to perform optical measurement operations with respect to upper areas of the user's head, or the back of the user's head. In some examples, headband 902 may include a swivel assembly at sections 904, which may allow headband 902 to be positioned in various locations on the user's head. Headband 902 may have any suitable width and may be flexible to cover top portions of the user's head.

Various implementations of optical measurement system 106 will now be described.

In some examples, optical measurement system 106 may be implemented by any suitable wearable system configured to perform optical-based brain data acquisition operations, such as any of the wearable optical measurement systems described in U.S. patent application Ser. No. 17/176,315, filed Feb. 16, 2021 and published as US2021/0259638A1; U.S. patent application Ser. No. 17/176,309, filed Feb. 16, 2021 and published as US2021/0259614A1; U.S. patent application Ser. No. 17/176,460, filed Feb. 16, 2021 and issued as U.S. Pat. No. 11,096,620; U.S. patent application Ser. No. 17/176,470, filed Feb. 16, 2021 and published as US2021/0259619A1; U.S. patent application Ser. No. 17/176,487, filed Feb. 16, 2021 and published as US2021/0259632A1; U.S. patent application Ser. No. 17/176,539, filed Feb. 16, 2021 and published as US2021/0259620A1; U.S. patent application Ser. No. 17/176,560, filed Feb. 16, 2021 and published as US2021/0259597A1; U.S. patent application Ser. No. 17/176,466, filed Feb. 16, 2021 and published as US2021/0263320A1; Han Y. Ban, et al., “Kernel Flow: A High Channel Count Scalable TD-fNIRS System,” SPIE Photonics West Conference (Mar. 6, 2021); and Han Y. Ban, et al., “Kernel Flow: a high channel count scalable time-domain functional near-infrared spectroscopy system,” Journal of Biomedical Optics (Jan. 18, 2022), which applications and publications are incorporated herein by reference in their entirety.

Additionally or alternatively, optical measurement system 106 may be configured to non-invasively measure blood oxygen saturation (SaO2) (e.g., at the ear) through Time-Resolved Pulse Oximetry (TR-SpO2), such as one or more of the devices described in more detail in U.S. Provisional Patent Application No. 63/134,479, filed Jan. 6, 2021, U.S. Provisional Patent Application No. 63/154,116, filed Feb. 26, 2021, U.S. Provisional Patent Application No. 63/160,995, filed Mar. 15, 2021, and U.S. Provisional Patent Application No. 63/179,080, filed Apr. 23, 2021, which applications are incorporated herein by reference. Using time-resolved techniques, information that allows for determining the absolute coefficients of absorption (μₐ) and reduced scattering (μₛ′) can be determined. From these absolute tissue properties, tissue oxygenation may be determined through the Beer-Lambert Law.

Additionally or alternatively, optical measurement system 106 may be configured to perform both optical-based brain data acquisition operations and electrical-based brain data acquisition operations, such as any of the wearable multimodal measurement systems described in U.S. patent application Ser. Nos. 17/176,315 and 17/176,309, which applications have already been incorporated herein by reference.

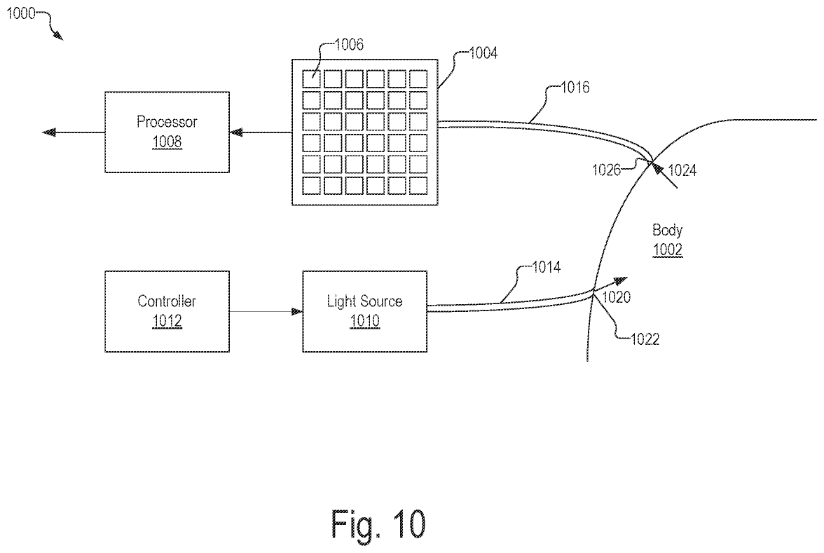

FIG. 10 shows an optical measurement system 1000 that may implement optical measurement system 106 and that may be configured to perform an optical measurement operation with respect to a body 1002 (e.g., the brain). Optical measurement system 1000 may, in some examples, be portable and/or wearable by a user.

In some examples, optical measurement operations performed by optical measurement system 1000 are associated with a time domain-based optical measurement technique. Example time domain-based optical measurement techniques include, but are not limited to, TCSPC, TD-NIRS, TD-DCS, and TD-DOT.

Optical measurement system 1000 (e.g., an optical measurement system that is implemented by a wearable device or other configuration, and that employs a time domain-based (e.g., TD-NIRS) measurement technique) may detect blood oxygenation levels and/or blood volume levels by measuring the change in shape of laser pulses after they have passed through target tissue, e.g., brain, muscle, finger, etc. As used herein, a shape of laser pulses refers to a temporal shape, as represented for example by a histogram generated by a time-to-digital converter (TDC) coupled to an output of a photodetector, as will be described more fully below.

As shown, optical measurement system 1000 includes a detector 1004 that includes a plurality of individual photodetectors (e.g., photodetector 1006), a processor 1008 coupled to detector 1004, a light source 1010, a controller 1012, and optical conduits 1014 and 1016 (e.g., light pipes). However, one or more of these components may not, in certain embodiments, be considered to be a part of optical measurement system 1000. For example, in implementations where optical measurement system 1000 is wearable by a user, processor 1008 and/or controller 1012 may in some embodiments be separate from optical measurement system 1000 and not configured to be worn by the user.

Detector 1004 may include any number of photodetectors 1006 as may serve a particular implementation, such as 10ⁿ photodetectors (e.g., 256, 512, . . . , 16384, etc.), where n is an integer greater than or equal to one (e.g., 4, 5, 8, 10, 11, 14, etc.). Photodetectors 1006 may be arranged in any suitable manner.

Photodetectors 1006 may each be implemented by any suitable circuit configured to detect individual photons of light incident upon photodetectors 1006. For example, each photodetector 1006 may be implemented by a single photon avalanche diode (SPAD) circuit and/or other circuitry as may serve a particular implementation. The SPAD circuit may be gated in any suitable manner or be configured to operate in a free running mode with passive quenching. For example, photodetectors 1006 may be configured to operate in a free-running mode such that photodetectors 1006 are not actively armed and disarmed (e.g., at the end of each predetermined gated time window). In contrast, while operating in the free-running mode, photodetectors 1006 may be configured to reset within a configurable time period after an occurrence of a photon detection event (i.e., after photodetector 1006 detects a photon) and immediately begin detecting new photons. However, only photons detected within a desired time window (e.g., during each gated time window) may be included in the histogram that represents a light pulse response of the target (e.g., a temporal point spread function (TPSF)). The terms histogram and TPSF are used interchangeably herein to refer to a light pulse response of a target.

Processor 1008 may be implemented by one or more physical processing (e.g., computing) devices. In some examples, processor 1008 may execute instructions (e.g., software) configured to perform one or more of the operations described herein.

Light source 1010 may be implemented by any suitable component configured to generate and emit light. For example, light source 1010 may be implemented by one or more laser diodes, distributed feedback (DFB) lasers, super luminescent diodes (SLDs), light emitting diodes (LEDs), diode-pumped solid-state (DPSS) lasers, super luminescent light emitting diodes (sLEDs), vertical-cavity surface-emitting lasers (VCSELs), titanium sapphire lasers, micro light emitting diodes (mLEDs), and/or any other suitable laser or light source. In some examples, the light emitted by light source 1010 is high coherence light (e.g., light that has a coherence length of at least 5 centimeters) at a predetermined center wavelength.

Light source 1010 is controlled by controller 1012, which may be implemented by any suitable computing device (e.g., processor 1008), integrated circuit, and/or combination of hardware and/or software as may serve a particular implementation. In some examples, controller 1012 is configured to control light source 1010 by turning light source 1010 on and off and/or setting an intensity of light generated by light source 1010. Controller 1012 may be manually operated by a user, or may be programmed to control light source 1010 automatically.

Light emitted by light source 1010 may travel via an optical conduit 1014 (e.g., a light pipe, a single-mode optical fiber, and/or or a multi-mode optical fiber) to body 1002 of a subject. Body 1002 may include any suitable turbid medium. For example, in some implementations, body 1002 is a brain or any other body part of a human or other animal. Alternatively, body 1002 may be a non-living object. For illustrative purposes, it will be assumed in the examples provided herein that body 1002 is a human brain.

As indicated by arrow 1020, the light emitted by light source 1010 enters body 1002 at a first location 1022 on body 1002. Accordingly, a distal end of optical conduit 1014 may be positioned at (e.g., right above, in physical contact with, or physically attached to) first location 1022 (e.g., to a scalp of the subject). In some examples, the light may emerge from optical conduit 1014 and spread out to a certain spot size on body 1002 to fall under a predetermined safety limit. At least a portion of the light indicated by arrow 1020 may be scattered within body 1002.

As used herein, “distal” means nearer, along the optical path of the light emitted by light source 1010 or the light received by detector 1004, to the target (e.g., within body 1002) than to light source 1010 or detector 1004. Thus, the distal end of optical conduit 1014 is nearer to body 1002 than to light source 1010, and the distal end of optical conduit 1016 is nearer to body 1002 than to detector 1004. Additionally, as used herein, “proximal” means nearer, along the optical path of the light emitted by light source 1010 or the light received by detector 1004, to light source 1010 or detector 1004 than to body 1002. Thus, the proximal end of optical conduit 1014 is nearer to light source 1010 than to body 1002, and the proximal end of optical conduit 1016 is nearer to detector 1004 than to body 1002.

As shown, the distal end of optical conduit 1016 (e.g., a light pipe, a light guide, a waveguide, a single-mode optical fiber, and/or a multi-mode optical fiber) is positioned at (e.g., right above, in physical contact with, or physically attached to) output location 1026 on body 1002. In this manner, optical conduit 1016 may collect at least a portion of the scattered light (indicated as light 1024) as it exits body 1002 at location 1026 and carry light 1024 to detector 1004. Light 1024 may pass through one or more lenses and/or other optical elements (not shown) that direct light 1024 onto each of the photodetectors 1006 included in detector 1004. In cases where optical conduit 1016 is implemented by a light guide, the light guide may be spring loaded and/or have a cantilever mechanism to allow for conformably pressing the light guide firmly against body 1002.

Photodetectors 1006 may be connected in parallel in detector 1004. An output of each of photodetectors 1006 may be accumulated to generate an accumulated output of detector 1004. Processor 1008 may receive the accumulated output and determine, based on the accumulated output, a temporal distribution of photons detected by photodetectors 1006. Processor 1008 may then generate, based on the temporal distribution, a histogram representing a light pulse response of a target (e.g., brain tissue, blood flow, etc.) in body 1002. Such a histogram is illustrative of the various types of brain activity measurements that may be performed by optical measurement system 1000.

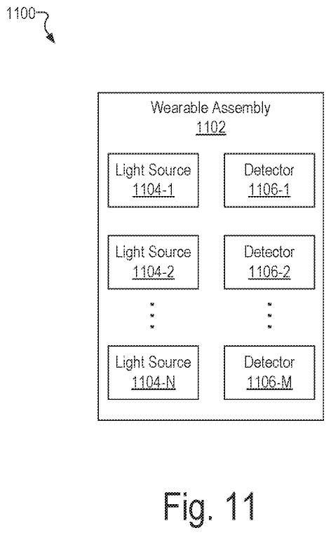

FIG. 11 shows an exemplary optical measurement system 1100 in accordance with the principles described herein. Optical measurement system 1100 may be an implementation of optical measurement system 1000 and, as shown, includes a wearable assembly 1102, which includes N light sources 1104 (e.g., light sources 1104-1 through 1104-N) and M detectors 1106 (e.g., detectors 1106-1 through 1106-M). Optical measurement system 1100 may include any of the other components of optical measurement system 1000 as may serve a particular implementation. N and M may each be any suitable value (i.e., there may be any number of light sources 1104 and detectors 1106 included in optical measurement system 1100 as may serve a particular implementation).

Light sources 1104 are each configured to emit light (e.g., a sequence of light pulses) and may be implemented by any of the light sources described herein. Detectors 1106 may each be configured to detect arrival times for photons of the light emitted by one or more light sources 1104 after the light is scattered by the target. For example, a detector 1106 may include a photodetector configured to generate a photodetector output pulse in response to detecting a photon of the light and a time-to-digital converter (TDC) configured to record a timestamp symbol in response to an occurrence of the photodetector output pulse, the timestamp symbol representative of an arrival time for the photon (i.e., when the photon is detected by the photodetector).

Wearable assembly 1102 may be implemented by any of the wearable devices, modular assemblies, and/or wearable units described herein. For example, wearable assembly 1102 may be integrated into one or more components of wearable glasses assembly 102.

Optical measurement system 1100 may be modular in that one or more components of optical measurement system 1100 may be removed, changed out, or otherwise modified as may serve a particular implementation. As such, optical measurement system 1100 may be configured to conform to three-dimensional surface geometries, such as a user's head. Exemplary modular optical measurement systems comprising a plurality of wearable modules are described in more detail in U.S. patent application Ser. No. 17/176,460, filed Feb. 16, 2021 and issued as U.S. Pat. No. 11,096,620, U.S. patent application Ser. No. 17/176,470, filed Feb. 16, 2021 and published as US2021/0259619A1, U.S. patent application Ser. No. 17/176,487, filed Feb. 16, 2021 and published as US2021/0259632A1, U.S. patent application Ser. No. 17/176,539, filed Feb. 16, 2021 and published as US2021/0259620A1, U.S. patent application Ser. No. 17/176,560, filed Feb. 16, 2021 and published as US2021/0259597A1, and U.S. patent application Ser. No. 17/176,466, filed Feb. 16, 2021 and published as US2021/0263320A1, which applications are incorporated herein by reference in their respective entireties.

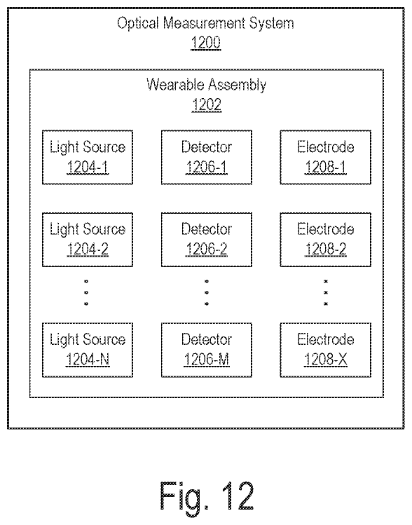

FIG. 12 shows an exemplary optical measurement system 1200 configured to perform both optical-based brain data acquisition operations and electrical-based brain data acquisition operations. Optical measurement system 1200 may at least partially implement optical measurement system 1000 and, as shown, includes a wearable assembly 1202 (which is similar to wearable assembly 1102), which includes N light sources 1204 (e.g., light sources 1204-1 through 1204-N, which are similar to light sources 1104), M detectors 1206 (e.g., detectors 1206-1 through 1206-M, which are similar to detectors 1106), and X electrodes (e.g., electrodes 1208-1 through 1208-X). Optical measurement system 1200 may include any of the other components of optical measurement system 1000 as may serve a particular implementation. N, M, and X may each be any suitable value (i.e., there may be any number of light sources 1204, any number of detectors 1206, and any number of electrodes 1208 included in optical measurement system 1200 as may serve a particular implementation).

Electrodes 1208 may be configured to detect electrical activity within a target (e.g., the brain). Such electrical activity may include electroencephalogram (EEG) activity and/or any other suitable type of electrical activity as may serve a particular implementation. In some examples, electrodes 1208 are all conductively coupled to one another to create a single channel that may be used to detect electrical activity. Alternatively, at least one electrode included in electrodes 1208 is conductively isolated from a remaining number of electrodes included in electrodes 1208 to create at least two channels that may be used to detect electrical activity.

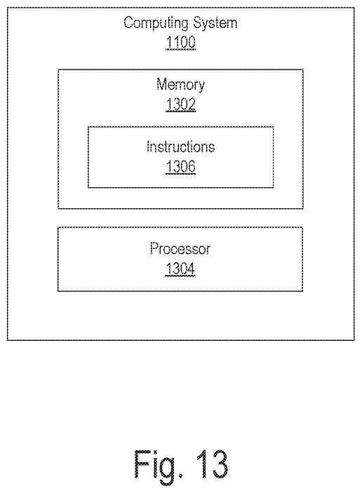

FIG. 13 shows an exemplary computing system 1300 that may implement processor 202. As shown, computing system 1300 may include memory 1302 and a processor 1304. Computing system 1300 may include additional or alternative components as may serve a particular implementation. Each component may be implemented by any suitable combination of hardware and/or software.

Memory 1302 may maintain (e.g., store) executable data used by processor 1304 to perform one or more of the operations described herein. For example, memory 1302 may store instructions 1306 that may be executed by processor 1304 to perform one or more operations based on optical measurement data output by optical measurement system 106 and visual experience output by viewing lens assembly 104. Instructions 1306 may be implemented by any suitable application, program, software, code, and/or other executable data instance. Memory 1302 may also maintain any data received, generated, managed, used, and/or transmitted by processor 1304.

Processor 1304 may be configured to perform (e.g., execute instructions 1306 stored in memory 1302 to perform) various operations described herein.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g. a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

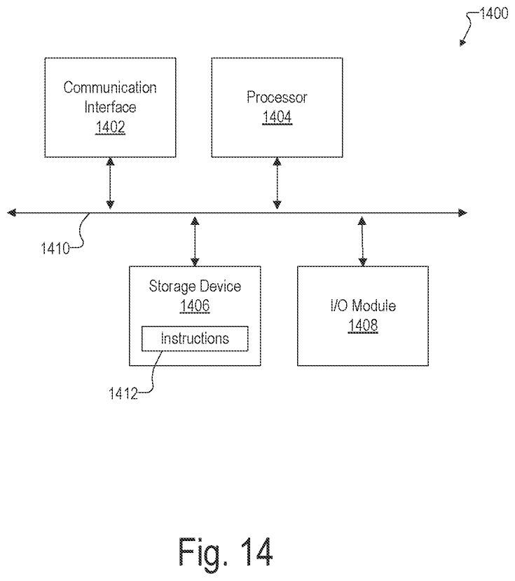

FIG. 14 illustrates an exemplary computing device 1400 that may be specifically configured to perform one or more of the processes described herein. Any of the systems, units, computing devices, and/or other components described herein may be implemented by computing device 1400.

As shown in FIG. 14, computing device 1400 may include a communication interface 1402, a processor 1404, a storage device 1406, and an input/output (“I/O”) module 1408 communicatively connected one to another via a communication infrastructure 1410. While an exemplary computing device 1400 is shown in FIG. 14, the components illustrated in FIG. 14 are not intended to be limiting. Additional or alternative components may be used in other embodiments. Components of computing device 1400 shown in FIG. 14 will now be described in additional detail.

Communication interface 1402 may be configured to communicate with one or more computing devices. Examples of communication interface 1402 include, without limitation, a wired network interface (such as a network interface card), a wireless network interface (such as a wireless network interface card), a modem, an audio/video connection, and any other suitable interface.

Processor 1404 generally represents any type or form of processing unit capable of processing data and/or interpreting, executing, and/or directing execution of one or more of the instructions, processes, and/or operations described herein. Processor 1404 may perform operations by executing computer-executable instructions 1412 (e.g., an application, software, code, and/or other executable data instance) stored in storage device 1406.

Storage device 1406 may include one or more data storage media, devices, or configurations and may employ any type, form, and combination of data storage media and/or device. For example, storage device 1406 may include, but is not limited to, any combination of the non-volatile media and/or volatile media described herein. Electronic data, including data described herein, may be temporarily and/or permanently stored in storage device 1406. For example, data representative of computer-executable instructions 1412 configured to direct processor 1404 to perform any of the operations described herein may be stored within storage device 1406. In some examples, data may be arranged in one or more databases residing within storage device 1406.

I/O module 1408 may include one or more I/O modules configured to receive user input and provide user output. I/O module 1408 may include any hardware, firmware, software, or combination thereof supportive of input and output capabilities. For example, I/O module 1408 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1408 is configured to provide graphical data to a display for presentation to a user. The graphical data may be representative of one or more graphical user interfaces and/or any other graphical content as may serve a particular implementation.

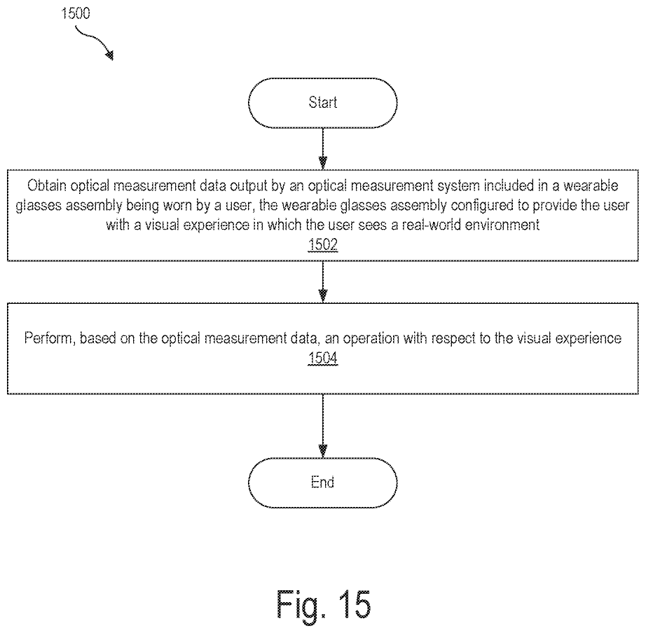

FIG. 15 illustrates an exemplary method 1500. While FIG. 15 illustrates exemplary operations according to one embodiment, other embodiments may omit, add to, reorder, and/or modify any of the operations shown in FIG. 15. One or more of the operations shown in FIG. 15 may be performed by processor 202 and/or any implementation thereof. Each of the operations illustrated in FIG. 15 may be performed in any suitable manner.

At operation 1502, a processor obtains optical measurement data output by an optical measurement system included in a wearable glasses assembly being worn by a user, the wearable glasses assembly configured to provide the user with a visual experience in which the user sees a real-world environment.

At operation 1504, the processor performs, based on the optical measurement data, an operation with respect to the visual experience.

An illustrative system includes a wearable glasses assembly configured to be worn by a user and comprising: a viewing lens assembly configured to provide the user with a visual experience in which the user sees a real-world environment through the viewing lens assembly; and an optical measurement system configured to output optical measurement data representative of one or more optical measurements performed with respect to the user.

Another illustrative system includes a wearable glasses assembly configured to be worn by a user and configured to provide the user with a visual experience in which the user sees a real-world environment; an optical measurement system included in the wearable glasses assembly, the optical measurement system configured to perform one or more optical measurements with respect to the user and output optical measurement data representative of the one or more optical measurements; and a processor configured to perform, based on the optical measurement data, an operation with respect to the visual experience.

An illustrative method includes obtaining, by a processor, optical measurement data output by an optical measurement system included in a wearable glasses assembly being worn by a user, the wearable glasses assembly configured to provide the user with a visual experience in which the user sees a real-world environment; and performing, by the processor based on the optical measurement data, an operation with respect to the visual experience.

An illustrative non-transitory computer-readable medium stores instructions that, when executed, direct a processor of a computing device to: obtain optical measurement data output by an optical measurement system included in a wearable glasses assembly being worn by a user, the wearable glasses assembly configured to provide the user with a visual experience; and perform, based on the optical measurement data, an operation with respect to the visual experience.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A system comprising:
a wearable glasses assembly configured to be worn by a user and comprising:
a viewing lens assembly configured to provide the user with a visual experience in which the user sees a real-world environment through the viewing lens assembly; and
an optical measurement system configured to output optical measurement data representative of one or more optical measurements performed with respect to the user.

2. The system of claim 1, further comprising a processor configured to perform, based on the optical measurement data, an operation with respect to the visual experience.

3. The system of claim 2, wherein the processor is included in the wearable glasses assembly.

4. The system of claim 2, wherein the processor is included in a device separate from the wearable glasses assembly.

5. The system of claim 2, wherein the performing the operation comprises adjusting, based on the optical measurement data, one or more attributes associated with the visual experience.

6. The system of claim 5, wherein the adjusting the one or more attributes associated with the visual experience comprises wirelessly transmitting one or more commands to one or more of the wearable glasses assembly or a computing device communicatively coupled to the wearable glasses assembly.

7. The system of claim 5, wherein the adjusting of the one or more attributes associated with the visual experience comprises controlling an operation of the wearable glasses assembly.

8. The system of claim 5, wherein the adjusting of the one or more attributes associated with the visual experience comprises controlling an operation of a computing device communicatively coupled to the wearable glasses assembly, the computing device configured to control the one or more attributes associated with the visual experience.

9. The system of claim 5, wherein the adjusting of the one or more attributes associated with the visual experience based on the optical measurement data comprises:
determining, based on the optical measurement data, an effect of the visual experience on the user; and
adjusting, based on the determined effect, the one or more attributes associated with the visual experience.

10. The system of claim 5, wherein the adjusting of the one or more attributes associated with the visual experience based on the optical measurement data comprises:
determining, based on the optical measurement data, a current mental state of the user;
obtaining data representative of a desired mental state of the user; and
adjusting, based on the current mental state and the desired mental state, the one or more attributes associated with the visual experience to change the current mental state of the user to the desired mental state of the user.

11. The system of claim 5, wherein:
the providing the user with the visual experience further comprises presenting, by way of the viewing lens assembly, augmented reality content associated with the real-world environment; and
the adjusting of the one or more attributes associated with the visual experience comprises adjusting one or more attributes associated with the augmented reality content.

12. The system of claim 2, wherein the performing the operation comprises presenting, by way of a graphical user interface, content associated with the optical measurement data.

13. The system of claim 2, wherein:
the wearable glasses assembly further comprises an imaging device configured to capture one or more images of the real-world environment as seen by the user; and
the performing of the operation is further based on the one or more images.

14. The system of claim 13, wherein:
the processor is further configured to identify, based on the one or more images, a real-world object in a field of view of the user; and
the performing of the operation is further based on the identifying of the real-world object.

15. The system of claim 13, wherein:
the processor is further configured to
identify, based on the one or more images, a person in a field of view of the user,
determine one or more attributes of the person; and
the performing of the operation is further based on the one or more attributes of the person.

16. The system of claim 2, wherein the performing the operation comprises presenting a notification to the user.

17. The system of claim 2, wherein the performing the operation comprises presenting audio content to the user.

18. The system of claim 2, wherein:
the wearable glasses assembly further comprises a microphone configured to detect sound; and
the performing of the operation is further based on the sound.

19. The system of claim 1, wherein:
the wearable glasses assembly further comprises a frame configured to be worn by the user; and
the optical measurement system is at least one of included in the frame or attached to the frame.

20. The system of claim 1, wherein:
the wearable glasses assembly further comprises a headband configured to be worn on a head of the user; and
the optical measurement system is included in the headband.

21. The system of claim 1, wherein the one or more optical measurements comprise one or more brain activity measurements.

22. The system of claim 1, wherein the one or more optical measurements comprise one or more non-invasive measurements of blood oxygen saturation (SaO2) through Time-Resolved Pulse Oximetry (TR-SpO2).

23. The system of claim 1, wherein the optical measurement system comprises:
a plurality of light sources each configured to emit light directed at a brain of the user, and
a plurality of detectors configured to detect arrival times for photons of the light after the light is scattered by the brain, the optical measurement data based on the arrival times.

24. The system of claim 23, wherein the detectors each comprise a plurality of single-photon avalanche diode (SPAD) circuits.

25. The system of claim 23, wherein the optical measurement system further comprises a plurality of electrodes configured to detect electrical activity of the brain, the optical measurement data further based on the electrical activity.

26. A system comprising:
a wearable glasses assembly configured to be worn by a user and configured to provide the user with a visual experience in which the user sees a real-world environment;
an optical measurement system included in the wearable glasses assembly, the optical measurement system configured to perform one or more optical measurements with respect to the user and output optical measurement data representative of the one or more optical measurements; and
a processor configured to perform, based on the optical measurement data, an operation with respect to the visual experience.

27. The system of claim 26, wherein the processor is included in the wearable glasses.

28. The system of claim 26, wherein the processor is included in a device separate from the wearable glasses assembly.

29. The system of claim 26, wherein the performing the operation comprises adjusting, based on the optical measurement data, one or more attributes associated with the visual experience.

30. The system of claim 29, wherein the adjusting the one or more attributes associated with the visual experience comprises wirelessly transmitting one or more commands to one or more of the wearable glasses assembly or a computing device communicatively coupled to the wearable glasses assembly.

31. The system of claim 29, wherein the adjusting of the one or more attributes associated with the visual experience comprises controlling an operation of the wearable glasses assembly.

32. The system of claim 29, wherein the adjusting of the one or more attributes associated with the visual experience comprises controlling an operation of a computing device communicatively coupled to the wearable glasses assembly, the computing device configured to control the one or more attributes associated with the visual experience.

33. The system of claim 29, wherein the adjusting of the one or more attributes associated with the visual experience based on the optical measurement data comprises:
determining, based on the optical measurement data, an effect of the visual experience on the user; and
adjusting, based on the determined effect, the one or more attributes associated with the visual experience.

34. The system of claim 29, wherein the adjusting of the one or more attributes associated with the visual experience based on the optical measurement data comprises:
determining, based on the optical measurement data, a current mental state of the user;
obtaining data representative of a desired mental state of the user; and
adjusting, based on the current mental state and the desired mental state, the one or more attributes associated with the visual experience to change the current mental state of the user to the desired mental state of the user.

35. The system of claim 29, wherein:
the providing the user with the visual experience further comprises presenting augmented reality content associated with the real-world environment; and
the adjusting of the one or more attributes associated with the visual experience comprises adjusting one or more attributes associated with the augmented reality content.

36. The system of claim 26, wherein the performing the operation comprises presenting, by way of a graphical user interface, content associated with the optical measurement data.

37. The system of claim 26, wherein:
the wearable glasses assembly comprises an imaging device configured to capture one or more images of the real-world environment as seen by the user; and
the performing of the operation is further based on the one or more images.

38. The system of claim 37, wherein:
the processor is further configured to identify, based on the one or more images, a real-world object in a field of view of the user; and
the performing of the operation is further based on the identifying of the real-world object.

39. The system of claim 37, wherein:
the processor is further configured to
identify, based on the one or more images, a person in a field of view of the user,
determine one or more attributes of the person; and
the performing of the operation is further based on the one or more attributes of the person.

40. The system of claim 26, wherein the performing the operation comprises presenting a notification to the user.

41. The system of claim 26, wherein the performing the operation comprises presenting audio content to the user.

42. The system of claim 26, wherein:
the wearable glasses assembly comprises a microphone configured to detect sound; and
the performing of the operation is further based on the sound.

43. The system of claim 26, wherein:
the wearable glasses assembly comprises a frame configured to be worn by the user; and
the optical measurement system is at least one of included in the frame or attached to the frame.

44. The system of claim 26, wherein:
the wearable glasses assembly comprises a headband configured to be worn on a head of the user; and
the optical measurement system is included in the headband.

45. The system of claim 26, wherein the one or more optical measurements comprise one or more brain activity measurements.

46. The system of claim 26, wherein the one or more optical measurements comprise one or more non-invasive measurements of blood oxygen saturation (SaO2) through Time-Resolved Pulse Oximetry (TR-SpO2).

47. The system of claim 26, wherein the optical measurement system comprises:
a plurality of light sources each configured to emit light directed at a brain of the user, and
a plurality of detectors configured to detect arrival times for photons of the light after the light is scattered by the brain, the optical measurement data based on the arrival times.

48. The system of claim 47, wherein the detectors each comprise a plurality of single-photon avalanche diode (SPAD) circuits.

49. The system of claim 47, wherein the optical measurement system further comprises a plurality of electrodes configured to detect electrical activity of the brain, the optical measurement data further based on the electrical activity.

50-63. (canceled)
